(19) United States
(12) Patent Application Publication
(10) Pub. No.: US 2019/0201285 A1
(43) Pub. Date: Jul. 4, 2019

(54) Child Resistant Medication Packaging

(71) Applicant: Mylan Inc., Canonsburg, PA (US)

(72) Inventors: Jeffrey Warden, Bala Cynwyd, PA (US); Eric Richardson, Cave Creek, AZ (US); JoAnna Terhune, Pittsaburgh, PA (US)

(73) Assignee: Mylan Inc., Canonsburg, PA (US)

(21) Appl. No.: 16/326,966

(22) PCT Filed: Aug. 22, 2017
(86) PCT No.: PCT/US2017/047910

§ 371 Date: Feb. 21, 2019

Related U.S. Application Data
(60) Provisional application No. 62/378,267, filed on Aug. 23, 2016.

(51) Int. Cl. A61J 1/03; A61J 7/00; B65D 50/02

(52) U.S. Cl. CPC A61J 1/03; B65D 2215/02; B65D 50/02; A61J 7/0076

(57) ABSTRACT

Medication packaging includes a housing. A medication container is attached with the housing by a tether. The medication container is engageable with the housing between a child resistant configuration and a medication accessible configuration. Systems and methods of use are disclosed.

### TECHNICAL FIELD

The present disclosure generally relates to medicament packaging and more particularly to a dispensing device and system that provides a medication regimen and/or child resistance and a method for treatment of a medical condition.

### BACKGROUND

Retail customers and/or patients can be engaged in a medical therapy, which may include diet, exercise and/or a prescription and/or a non-prescription medication dosing regimen, which may be employed to treat an illness. In some cases, hospitalized patients are often discharged and instructed by one or more medical practitioners to comply with a medical therapy.

Such medication dosing regimen can include one or a plurality of medications administered over a regimen, which may include one or more medications. The medication dosing regimen can require administration of medications simultaneously, at different times and/or according to days of a week or time of day. Such medication regimens may be administered in addition to existing medication regimens that a user may take for nutritional, therapeutic and/or illness treatment.

Such medication regimens, however, often suffer from poor patient compliance. In fact, many patients fail to comply with their medication regimens. In some cases, life-style related medications may also suffer from poor user compliance. Factors that contribute to non-compliance may include complexity of medication regimen, patient failure in filling prescriptions, incorrect order and/or prescription, cost, adverse side effects, patient reluctance, lack of motivation, non-reconciliation with existing medication and/or patient physiological issues.

Various medications of a medication regimen can be dispensed from a medication container such as single dose and/or multiple dose blister packaging to a user with or without child resistance. Multiple dose blister packaging can dispense a single medication according to a regimen including day, e.g., Monday, Tuesday, etc. and/or time of day. This disclosure describes an improvement over these prior technologies.

### SUMMARY

In some embodiments, a medication packaging is provided. The medication packaging includes a housing. A medication container is attached with the housing by a tether. The medication container is engageable with the housing between a child resistant configuration and a medication accessible configuration. Systems and methods of use are also disclosed.

### BRIEF DESCRIPTION OF THE DRAWINGS

The present disclosure will become more readily apparent from the specific description accompanied by the following drawings, in which:

FIG. 1 is a perspective view of components of one embodiment of a system in accordance with the principles of the present disclosure;

FIG. 1A is an enlarged cross section view of components of the system shown in FIG. 1;

FIG. 2 is a perspective view of components of the system shown in FIG. 1;

FIG. 3 is a perspective view of components of the system shown in FIG. 1;

FIG. 3A is an enlarged cross section view of components of the system shown in FIG. 3;

FIG. 4 is a perspective view of components of the system shown in FIG. 1;

FIG. 5 is a perspective view of components of the system shown in FIG. 1;

FIG. 6 is a perspective view of components of one embodiment of a system in accordance with the principles of the present disclosure;

FIG. 7 is a perspective view of components of one embodiment of a system in accordance with the principles of the present disclosure;

FIG. 8 is a perspective view of components of one embodiment of a system in accordance with the principles of the present disclosure;

FIG. 9 is a perspective view of components of the system shown in FIG. 8;

FIG. 10 is a perspective view of components of the system shown in FIG. 8;

FIG. 11 is a perspective view of components of the system shown in FIG. 8;

FIG. 12 is a perspective view of components of the system shown in FIG. 8;

FIG. 13 is a perspective view of components of the system shown in FIG. 8;

FIG. 14 is a perspective view of components of one embodiment of a system in accordance with the principles of the present disclosure;

FIG. 15 is a perspective view of components of the system shown in FIG. 14;

FIG. 16 is a perspective view of components of one embodiment of a system in accordance with the principles of the present disclosure;

FIG. 17 is a perspective view of components of the system shown in FIG. 16;

FIG. 18 is a perspective view of components of one embodiment of a system in accordance with the principles of the present disclosure;

FIG. 19 is a perspective view of components of one embodiment of a system in accordance with the principles of the present disclosure;

FIG. 20 is an enlarged break away view of components of the system shown in FIG. 18;

FIG. 21 is an enlarged break away view of components of the system shown in FIG. 18;

FIG. 22 is an enlarged break away view of components of the system shown in FIG. 18; and

FIG. 23 is an enlarged break away view of components of the system shown in FIG. 18.

### DETAILED DESCRIPTION

The exemplary embodiments of a medicament packaging system and related methods of use disclosed are discussed in terms of dispensing devices for the treatment of various diseases, illness and/or ailments and more particularly, in terms of a medicament dispensing device and system that provides a medication regimen and/or child resistance and a method for treatment of a medical condition. In some embodiments, the present system is employed with a method for distribution of medication packaging to a patient for treatment of one or more diseases, illness and/or ailments. In some embodiments, the present system is employed with a method such that a patient is discharged from a health care facility, for example, short term discharge and/or long term discharge.

In some embodiments, the medicament packaging system includes a locking mechanism to facilitate a child resistant medicament packaging system. In some embodiments, the locking mechanism includes one or a plurality of openings, such as, for example, a pair of circular holes engageable with protrusions, such as, for example, buttons. In some embodiments, the holes are disposed with a surface of a housing of the medicament packaging system. In some embodiments, the buttons are configured for an offset engagement with the circular holes to resist and/or prevent opening. In some embodiments, the protrusions are circular. In some embodiments, the buttons include various shapes configured to fit through the holes. In some embodiments, the buttons are configured to form a friction fit engagement with a surface of the holes such that a downward force applied to the buttons will not release the buttons from the holes until the buttons are translated and aligned with the holes.

In some embodiments, the medicament packaging system includes a housing, such as, for example, a sleeve and a medication container configured with a spring force that causes the buttons to apply a force in a first direction to engage a surface of the holes in a friction fit and/or an interference fit configuration to resist and/or prevent release. In some embodiments, the locking mechanism is actuated by a patient sliding the buttons in a second, opposite direction to align the buttons with the holes. In some embodiments, the buttons are then pressed in a downward direction, while holding the medication container, to release the medication container from the sleeve. In some embodiments, the patient draws or pulls the medication container from the sleeve. In some embodiments, the medication container is released and resiliently expands from the sleeve to facilitate unrolling to view the medications. In some embodiments, pushing a rolled up medication container back into the sleeve will lock the medication with the sleeve.

In some embodiments, the buttons are disposed on a top surface of the sleeve. In some embodiments, the buttons are disposed on a bottom surface, a rear surface and/or a combination of a top and a bottom surface to facilitate a child resistant locking mechanism.

In some embodiments, the buttons are configured with various shapes and are releasable from the holes without having to push the medication container. In some embodiments, the buttons may be configured for translation in opposite directions relative to each other to facilitate alignment. In some embodiments, the buttons are configured to pass through circular holes. In some embodiments, the buttons are engageable without holes in the sleeve. In some embodiments, the locking mechanism includes a plastic finger configured to capture the medication container.

In some embodiments, the system includes a housing, such as, for example, a box having a cover and a bottom. The medication container is disposed with the box and includes a scroll configuration. In some embodiments, the box includes a locking mechanism. In some embodiments, the locking mechanism includes openings disposed with a corner surface of the box, such as, for example, a back corner surface. In some embodiments, the positioning of the openings provides a complete coverage box configuration. In some embodiments, the openings are viewable when the cover is in an opened orientation. In some embodiments, the box includes at least two openings, one configured for engagement with a locking tab and the other configured to facilitate opening of the medication container, such as, for example, by lifting.

In some embodiments, one of the openings includes a locking tab, such as, for example, a resilient spring tab. In some embodiments, the spring tab includes a plastic material. In some embodiments, the spring tab is configured to engage the medication container to resist and/or prevent opening of the medication container until the spring tab is actuated. In some embodiments, actuation of the spring tab includes pushing the spring tab in a direction away from the medication container while inserting a finger into the other opening to lift the medication container for opening. In some embodiments, the medication container includes a scroll configuration and unrolls for opening. In some embodiments, the medication container is rolled back to an original configuration and engaged with the spring tab for locking.

In some embodiments, the system includes a medication container including medication cards having a twice a day medication dose, such as, for example, a morning dose and an evening dose. In some embodiments, the medication cards include a first row of the medication dose and a second row of the medication dose. In some embodiments, the second row is offset and/or staggered relative to the first row. In some embodiments, gaps are disposed between the medication doses in the first row such that the medication doses in the second row are configured to nest within the gaps when the medication container is rolled closed.

In some embodiments, the medication container includes a medication card having a plurality of openings. In some embodiments, a strip of medication doses are configured for disposal with the openings. In some embodiments, the strip of medication doses is configured to be adhered to the medication card.

In some embodiments, the box has a bottom portion. In some embodiments, the bottom portion includes a heavy gauge material. In some embodiments, the box includes a cover disposed with the medication container. In some embodiments, the medication container includes a lighter gauge material. In some embodiments, the medication container is disposed with the box and includes a scroll configuration. In some embodiments, the box includes a locking mechanism. In some embodiments, the locking mechanism includes a latch mechanism. In some embodiments, the latch mechanism is disposed on an inner surface of the box. In some embodiments, the latch mechanism includes a top slider having a hook and a bottom slider having a hook configured for disposal between a child resistant locked orientation and a medication accessible opened orientation.

In some embodiments, the latch includes a first slide and a second slide that require two hands to translate the slides in opposite directions for disengagement from a child resistant locked orientation to a medication accessible opened orientation. In some embodiments, both slides are translated in opposite directions for disengagement from a child resistant locked orientation to a medication accessible opened orientation, and translation of a single slide will not disengage the latch mechanism from a child resistant locked orientation to a medication accessible opened orientation. In some embodiments, the latch automatically engages and disposes into a child resistant locked orientation when the medication container is returned to the closed position with the housing, for example, via spring biased engagement of the latch hooks.

In one embodiment, the present system is employed with a method such that a patient is discharged from a health care facility, such as, for example, a hospital after one or more diseases, illness and/or ailments, such as, for example, myocardial infarction and may be prescribed one or more medications. In some embodiments, a patient may be directed and/or prescribed medication, such as, for example, an anti-platelet agent, aspirin, a beta-blocker, an ACE inhibitor, an ARB statin, nitro-glycerin, a docusate and/or anti-depressants. In some embodiments, the present system is employed to avoid failure of a patient to comply with such regimens and/or to take medications as prescribed or directed. In some embodiments, compliance failure can include the patient failing to refill the prescription, forgetting to take the prescribed medication, incomplete dosage and/or taking the medication at the incorrect time. In some embodiments, the present system is employed with a method for chronic dosing, for example, 30 day scripts or 90-100 day mail order refills. In some embodiments, the present system is employed with a method to facilitate compliance. In some embodiments, the present system is employed with a method to display and/or prove compliance. For example, a patient attending a practitioner appointment provides a present system, such as, for example, a compliance pack and displays and/or shows the practitioner use of the compliance pack, which may include rupture of one or more blister packs to evidence compliance, as described herein. In some embodiments, the present system is employed with a method for distribution of medication packaging to a patient for treatment of one or more diseases, illness and/or ailments, such as, for example, pneumonia, heart failure, pain, infectious diseases that may include administration of medications, such as, for example, anti-retrovirals (ARV) for treatment of HIV/AIDS, dyslipidemia (high cholesterol), hypertension (high blood pressure), metabolic syndrome/insulin intolerance related to diabetes, psychological diseases and/or administration of transplant/anti-rejection drugs.

In some embodiments, the present system comprises a medicament dispensing system and methods of use for storage, transportation and discharge of medications for the treatment of a medical condition. In some embodiments, the present system comprises a medicament dispensing system and methods of use for storage, transportation and discharge of medications including those for treating illnesses, such as, for example, elevated blood pressure, dyslipidemia (high cholesterol), diabetes, metabolic syndrome, heart failure, pneumonia, cardiac deficiencies, arthritis, illnesses in which pain is part of an on-going treatment plan, and/or life-style related medications such as, for example, birth control pills, hormone replacement pills and nutritional supplements, such as, for example, neutraceuticals, for example, having vitamin A, D, and E with a calcium supplement. In some embodiments, the method includes treatment of a heart condition following a myocardial infarction. In one embodiment, the systems and methods of the present disclosure are employed to aid a person with a medical condition requiring administration of multiple pills, doses or schedules as part of a regimen. In one embodiment, the present system and methods of the present disclosure include a medicament dispensing device that provides child resistance, while being easily accessed by an adult.

In one embodiment, the medication container may include multiple medications on a blister card. In one embodiment, the medication container is disposable after a certain period of time, such as, for example, about one week to about 90 days, with a specific embodiment being disposable after one week for up to 5 medications to be taken once a day. In some embodiments, one or more blister cards are provided pre-filled with medication, as described herein, from a manufacturer. In some embodiments, a practitioner, such as, for example, a pharmacist determines and selects one or more of the pre-filled blister cards based on doctor's prescription and creates the medication container. In some embodiments, the manufacturer provides a medication container packed with selected blister cards and pre-filled medication according to the doctor's prescription. In one embodiment, the medication container includes a seven day regimen blister strip.

In one embodiment, the medication container comprises an outer sleeve and an inner container, such as, for example, a scroll pack. In some embodiments, the medication container is configured to organize multiple medicines in an easily understood manner. In some embodiments, the sleeve and/or the inner container are made from card stock. In some embodiments, the inner container is configured to be removed from the sleeve to allow a patient access to medicaments held therein. In some embodiments, the inner container is tethered to the sleeve. In some embodiments, the sleeve comprises an open face from which the inner container is removed. In some embodiments, the sleeve includes a tab to engage and lock the inner container in place. In some embodiments, the inner container comprises a plurality of medication cards and is configured to be unwound after being removed from the sleeve. In some embodiments, each of the medication cards is configured to fold over itself and forms a generally rectangular cross sectional shape. In some embodiments, the medication cards are folded along a longitudinal axis, such that a front-facing outer surface comprises a medication strip, and a front-facing inner surface comprises a medication information label. In some embodiments, the inner container is sized to fit a number of medication cards for a patient's treatment regimen. In some embodiments, the inner container is configured to hold five medication cards. In some embodiments, the inner container can be sized to fit at least one card.

In some embodiments, the inner container is a segmented strip having pre-made folding lines defining medication card portions arranged in an alternating pattern. In some embodiments, the medication card portions comprise folding flaps configured to fold over a medication card and hold it in place. In some embodiments, the medication card comprises cutouts corresponding to the folding flaps of the inner container. In some embodiments, inner surfaces of the folding flaps comprise an adhesive material to adhere to the medication card to the scroll. In some embodiments, when all medication cards are adhered to the scroll container, multiple medication dosages are presented in a grid to present a patient's dosage regimen in an easily read manner.

In some embodiments, each medication card comprises seven receptacles for medicament doses, one for each day of the week. In some embodiments, the medication cards are arranged with indicia illustrating the day of the week corresponding with the intended dosage. In some embodiments, the medication cards are arranged to facilitate compliance with a complex dosage regimen. In some embodiments, the medication cards are configured such that a patient may take one medication from each medication card each day. In some embodiments, the medication cards are configured such that a patient takes all ‘Monday’ dosages at once, which are organized along a vertical column of the grid. In some embodiments, the medication cards are configured such that after taking the dosages, the crushed remnants remaining in the receptacles indicate a compliance record and direct the patient to take the dosages for the next day.

In some embodiments, the medication container comprises an outer sleeve and an inner container having a plurality of medication cards arranged in a step-like manner. In some embodiments, the medication cards are arranged on a sloped structure such that each of the cards is partially visible to a patient. In some embodiments, the container comprises a plurality of medication cards. In some embodiments, each of the medication cards is configured to fold over itself to form a generally rectangular cross sectional shape. In some embodiments, the medication cards are folded along a longitudinal axis, such that a front-facing outer surface comprises a medication strip, and a front-facing inner surface comprises a medication information label. In some embodiments, the medication cards include a bottom member having a plurality of receptacles and a removable lid. In some embodiments, the medication cards comprise seven receptacles each, one for each day of the week. In some embodiments, the lid comprises a foil comprising seven strips, each of the strips configured to cover a corresponding receptacle. In some embodiments, the foil strips can be peeled from the bottom member to allow access to a medicament dosage held within the receptacle. In some embodiments, the strips comprise an end portion comprising indicia, such as color, a number, or a day of the week, to illustrate to a patient a day of the week corresponding with the intended dosage. In some embodiments, the strips are separable by perforated lines. In some embodiments, the receptacles are configured to be crushed or disfigured by a patient to release the medicament dosage held within. In some embodiments, the medication cards are overlaid on one another such that the indicia of each card is visible. In some embodiments, the medication cards are arranged such that a patient can easily discern which medicaments remain on a given day and which medicaments have been taken already. In some embodiments, the medication container has a length of about 8.25 inches, a width of about 4.754 inches, and a height of about 1.75 inches.

In some embodiments, the medication container comprises closures and opening tabs, and/or a child resistance push/slide lock. In some embodiments, the medication container comprises internal card retaining clips. In some embodiments, the clips include a hook to prevent removal of the medication cards. In some embodiments, the clips include a hook that is configured to allow a patient to remove and/or replace medication cards. In some embodiments, the clips allow pharmacists to remove or reposition medicine cards as needed and permanently lock the cards by breaking off a tab from the clip to resist and/or prevent the patient from easily removing cards.

In some embodiments, the medication container includes a panel disposed on a top surface of the medication container. In some embodiments, the panel is configured to be opened and may include, such as, for example, additional product literature, a place for the patient to take notes about their experiences with the medicines, and/or helpful tips. In some embodiments, the panel can be utilized without opening the medication container.

In some embodiments, the medication container includes a closure panel having a flap configured for opening and closing the medication container. In some embodiments, the flap is configured to be tucked into the medication container. In some embodiments, the flap is configured to completely close the medication container during transit or when not in use.

In some embodiments, the medication container includes a flap having a half moon shaped opening configured to facilitate opening and closing. In some embodiments, the flap having a half moon shaped opening configured to facilitate opening with a dragging motion. In some embodiments, the medication container is manufactured from a single piece of card stock, which can include folded and/or glued components.

In one embodiment, the medicament dispensing system provides a complex dosage regimen for medications for a period of time, such as, for example, one week. In some embodiments, the complex dosage regimen for the medications is provided for a period lasting until a patient's first outpatient visit following release from a hospital. In one embodiment, one or more medications are included in a medicament dispensing system. In one embodiment, medications prescribed to a patient following a medical procedure are included in a medicament dispensing system. In one embodiment, medications previously being taken by a patient are included in a medicament dispensing system.

In some embodiments, the present system comprises medication packaging that includes one or more medications. In some embodiments, the medication packaging includes a member, such as, for example, a unit dose page including indicia. In some embodiments, the indicia include information regarding medication and dosages required by a prescribed and/or non-prescribed regimen. In some embodiments, the indicia include a description of medication, which may include a name of a drug and a medical effect of a drug. In one embodiment, the unit dose page may include indicia that represent other medications or dosages to accommodate patients as needed. In one embodiment, the unit dose page may include space for adding indicia that represent other medications or dosages to accommodate patients as needed. In one embodiment, the indicia are screen printed on the unit dose page. In one embodiment, the indicia are hand written on the unit dose page.

In some embodiments, the present system comprises a medicament dispensing system that is partially or entirely filled and packaged by a pharmacist. In some embodiments, the medicament dispensing system comprises a resilient material, such as, for example, cardboard. In some embodiments, the medicament dispensing system provides a child-resistant package while being easily accessible by an adult. In some embodiments, a method for accessing medication within the medicament dispensing system is provided. In some embodiments, the method includes the step of requiring consecutive and/or simultaneous motions difficult for children to perform but simple for an adult to perform. In one embodiment, the medication packaging comprises a slidable locking mechanism. In some embodiments, the locking mechanism is movable between a non-locked position and a locked position. In some embodiments, the locking mechanism provides audible indication of movement between a non-locked position and a locked position.

In one embodiment, the present system includes a medication treatment regimen comprising a plurality of medications. In one embodiment, the present system comprises a medicament dispensing system that provides an organization of each medication in a patient's complex dosage regimen. In one embodiment, each distinct medication in the regimen is stored on separate unit dose pages contained in a medicament packaging container. In one embodiment, the present system is employed with a method that includes one or a plurality of days of therapy provided on each unit dose page. In one embodiment, the present system is employed with a method that includes fourteen days of therapy provided on each unit dose page. In one embodiment, medication packaging includes one or more unit dose pages assembled, filled and sealed by a pharmacist. In one embodiment, the medicament packaging container is child resistant and the unit dose pages are not child resistant.

The present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. In some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

As used in the specification and including the appended claims, “treating” or “treatment” of a disease or condition may include administering one or more medications to a patient (human or other mammal). Alleviation can occur prior to signs or symptoms of the disease or condition appearing, as well as after their appearance. Thus, treating or treatment includes preventing or prevention of disease or undesirable condition (e.g., preventing the disease from occurring in a patient, who may be predisposed to the disease but has not yet been diagnosed as having it). In addition, treating or treatment does not require complete alleviation of signs or symptoms, does not require a cure, and specifically includes procedures that have only a marginal effect on the patient. Treatment can include inhibiting the disease, e.g., arresting its development, or relieving the disease, e.g., causing regression of the disease. For example, treatment includes, but is not limited to, reducing acute or chronic inflammation, inducing an anti-platelet effect, reducing hypertension, and lowering cholesterol.

In some embodiments, a biologically-active substance includes any substance or substances comprising a medicament, medication or drug including an active therapeutic substance, metabolite, hormone, steroid, vitamin, fatty acid, amino acid, sugar, carbohydrate, polypeptide or mineral. In some embodiments, a biologically-active substance includes any substance used for treatment, prevention, diagnosis, cure or mitigation of disease or illness. In some embodiments, a biologically-active substance includes any substance that affects anatomical structure or physiological function. In some embodiments, a biologically-active substance includes any substance that alters the impact of external influences on an animal, or metabolite thereof. In some embodiments, a complex dosage regimen includes a systematic administration of multiple dosage units at designated times during the day. In some embodiments, a dose includes each individual release of substance into body tissue.

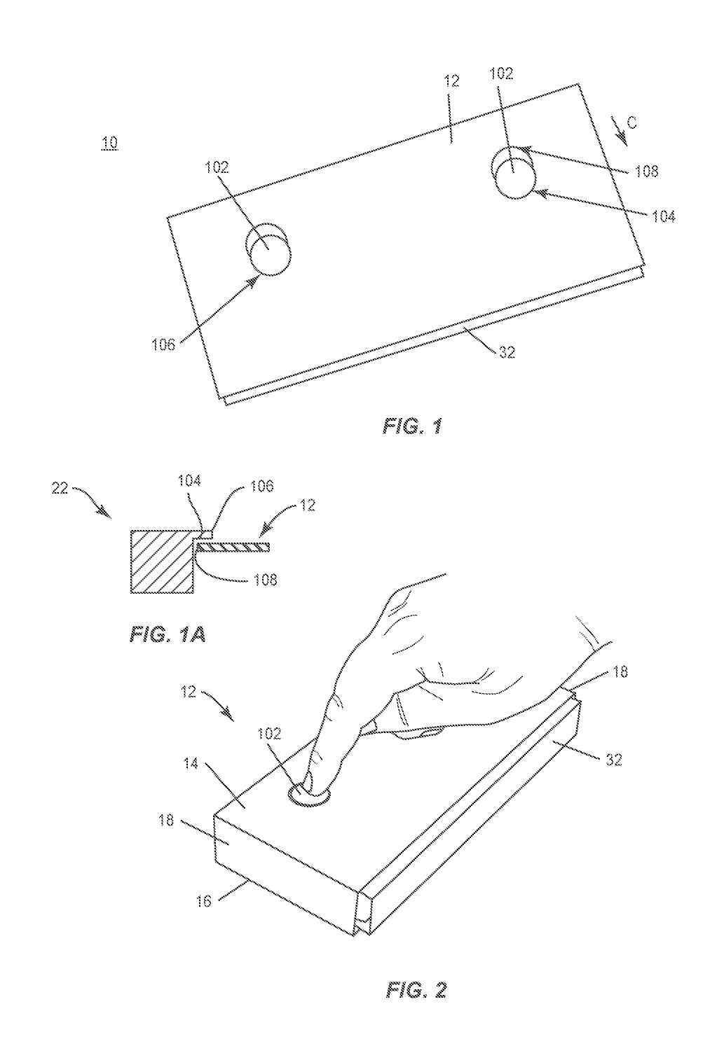

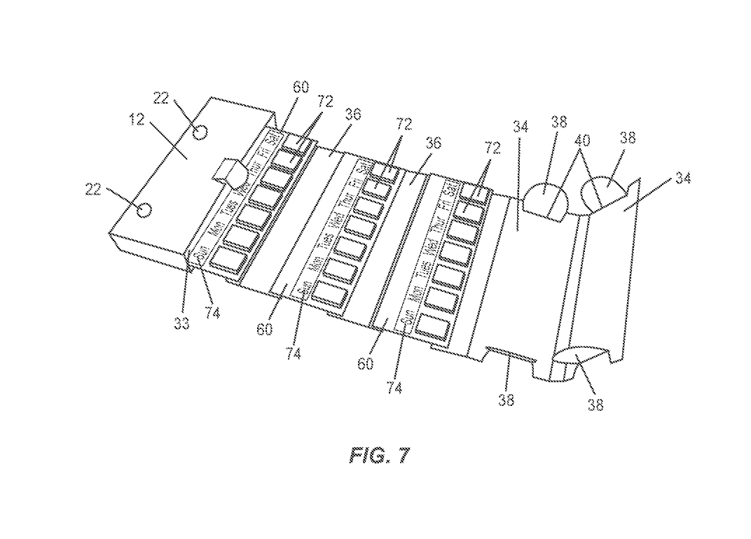

The following discussion includes a description of a medicament dispensing system including a medicament dispensing container, related components and methods of employing the medicament dispensing system. Alternate embodiments are also disclosed. Reference is made in detail to the exemplary embodiments of the present disclosure, which are illustrated in the accompanying figures. Turning to FIGS. 1-7, there are illustrated components of a medicament dispensing system 10.

The components of medicament dispensing system 10, individually or collectively, can be fabricated from materials suitable for storage and dispensing of medication. In some embodiments, such materials include metals, ceramics, synthetic polymers such as thermoplastics, semi-rigid and rigid materials, elastomers, fabric and/or their composites. Various components of medicament dispensing system 10 may have material composites, including the above materials, to achieve various desired characteristics such as strength, rigidity, elasticity, compliance, and durability. The components of medicament dispensing system 10, individually or collectively, may also be fabricated from a heterogeneous material such as a combination of two or more of the above-described materials. The components of medicament dispensing system 10 may be monolithically formed, integrally connected or include fastening elements and/or instruments, as described herein.

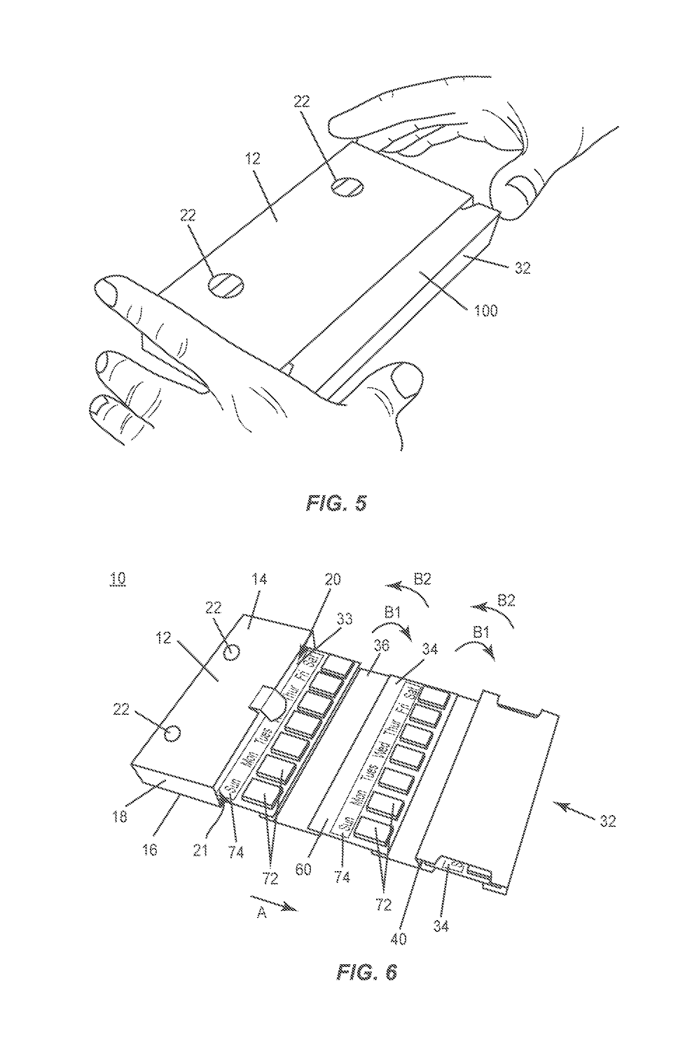

Medicament dispensing system 10 includes a housing, such as, for example, a pocket and/or sleeve 12 having a generally rectangular cross-sectional shape. Sleeve 12 includes a top face 14, a bottom face 16 and sidewalls 18. In one embodiment, top face 14 and bottom face 16 have rectangular shapes. Sleeve 12 includes a surface that defines an inner cavity 20, as shown in FIG. 6. Inner cavity 20 includes a passageway configured to receive a medication container, such as, for example, a scroll container 32, as discussed herein. Sleeve 12 includes an opening 22 disposed between top face 14 and bottom face 16 configured to provide access to inner cavity 20. In some embodiments, all or only a portion of sleeve 12, top face 14 and/or bottom face 16 may have alternate cross section configurations, such as, for example, oval, oblong triangular, square, polygonal, irregular, uniform, non-uniform, offset, staggered, and/or tapered. In some embodiments, sleeve 12 includes one or a plurality of openings 22. In some embodiments, sleeve 12 includes a pair of openings 22, as shown in FIG. 5. In some embodiments, openings 22 include a circular configuration. In some embodiments, all or only a portion openings 22 may have alternate cross section configurations, such as, for example, oval, oblong triangular, square, polygonal, irregular, uniform, non-uniform, offset, staggered, and/or tapered.

Scroll container 32 is configured for disposal within inner cavity 20, as described herein. Scroll container 32 is attached with sleeve 12 by a tether 33. Tether 33 is configured such that scroll container 32 is drawn from sleeve 12 but not detachable from sleeve 12. In some embodiments, scroll container 32 is attached to an inner surface of a sidewall 18 positioned opposite the opening to inner cavity 20. In some embodiments, scroll container 32 is attached to an inner surface of top face 14 or bottom face 16 adjacent the opening to inner cavity 20. Tether 33 may be made from a material similar to that of sleeve 12 and/or scroll container 32, such as, for example, card stock that is adhered to an inner surface of sleeve 12 with an adhesive material. In some embodiments, tether 33 may comprise a material that is different from that of sleeve 12 and scroll container 32, such as, for example, a fabric or a polymer composite, such as nylon.

Tether 33 is configured to provide a range of motion for movement of scroll container 32 relative to sleeve 12. In some embodiments, scroll container 32 is pivotable about tether 33 in an angular range of 0 to 360 degrees. In some embodiments, tether 33 is configured to provide movement of scroll container 32 within a predetermined distance from sleeve 12 to allow scroll container 32 to be unrolled.

In some embodiments, indicia is provided on sleeve 12 to provide instructions to aid a user in removing scroll container 32 from sleeve 12. In some embodiments, the indicia are positioned on a surface of scroll container 32 visible from an opening in sleeve 12. For example, the indicia may be in the form of instructive text such as “pull here” that may be printed onto the surface of scroll container 32. As shown in FIG. 1, scroll container 32 is removed from sleeve 12 by translating scroll container 32 out of inner cavity 20, in a direction shown by arrow A in FIG. 6, to display the contents of scroll container 32, as described herein.

In some embodiments, medicament dispensing system 10 includes child resistance features, while being easily accessible by an adult. For example, medicament dispensing system 10 includes scroll container 32 being engageable with sleeve 12 such that the components are movable between a child resistant, locked and/or medication non-accessible configuration, as shown for example in FIG. 1, and an unlocked and/or medication accessible configuration, as shown for example in FIG. 5.

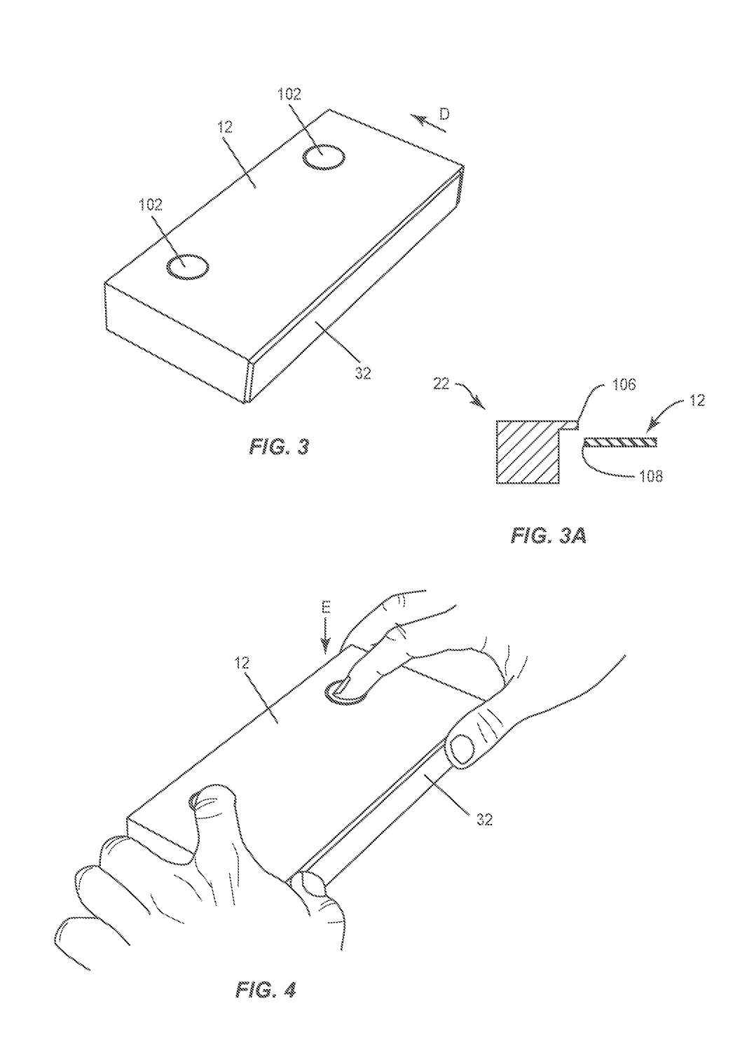

In some embodiments, scroll container 32 includes a surface 100 that defines protrusions, such as, for example, buttons 102. Buttons 102 each include a surface 104 that defines a protrusion 106, as shown in FIGS. 1A and 3A. In some embodiments, protrusion 106 extends laterally from button 102 to engage and be retained by a surface 108 of sleeve 12. In some embodiments, protrusion 106 may extend at alternate orientations, relative to button 102, such as, for example, transverse, and/or other angular orientations such as acute or obtuse, co-axial and/or may be offset or staggered. In some embodiments, button 102 can include one or a plurality of protrusions 106 disposed radially about surface 104.

Surface 104 is configured to engage a surface 108 of sleeve 12, as shown in FIG. 1A. Protrusion 106 is disposed in an offset alignment relative to opening 22 to obstruct passage of buttons 102 through openings 22. Surfaces 104, 108 are disposed in an interference fit to resist and/or prevent disengagement of scroll container 32 from sleeve 12. Buttons 102 are configured for disposal between a child resistant locked configuration (FIGS. 1 and 1A) and an opened, medication accessible configuration (FIGS. 3 and 3A). In the locked configuration, the interference fit is formed by a resilient force applied by scroll container 32, in a direction shown by arrow C in FIG. 1. In some embodiments, scroll container 32 is resiliently disposed in sleeve 12 due to a resilient material forming scroll container 32 and/or tether 33.

Buttons 102 are manipulated and/or translated by sliding scroll container 32, in a direction shown by arrow D in FIG. 3, causing disengagement of surface 104 from surface 108, as shown in FIG. 3A, to dispose sleeve 12 and scroll container 32 in the opened, medication accessible configuration. Manipulation of buttons 102 causes buttons 102 to align with openings 22. In this position, buttons 102 are able to pass through openings 22 without obstruction. Once buttons 102 are aligned with openings 22, buttons 102 are pushed in a downward direction, as shown by arrow E in FIG. 4, to release scroll container 32 from sleeve 12.

In some embodiments, instructive indicia are positioned adjacent openings 22 to aid a user in moving medicament dispensing system 10 from the child resistant locked configuration to an opened configuration. In some embodiments, the indicia are positioned on a surface of sleeve 12 and/or adjacent openings 22. In some embodiments, the indicia may be marked by an arrow indicating the direction of movement to move openings 22. In some embodiments, instructive text such as “push here” may be printed on or adjacent to openings 22 to indicate the direction of movement to move openings 22.

In some embodiments, scroll container 32 comprises a plurality of medication card portions 34 and spine portions 36 in an alternating pattern. Medication card portions 34 are sized to receive medication cards 60, as discussed herein. When fully unrolled, scroll container 32 extends from opening 21 of sleeve 12 with spine portions 36 being positioned between medication cards 60. In various embodiments, medication card portions 34 are wider than spine portions 36. Portions 34, 36 are sized to allow rolling of scroll container 32. In some embodiments, adjacent spine portions 36 include varying lengths to accommodate extension of a plurality of medication cards 60.

In some embodiments, medication cards 60 are attachable to designated portions on scroll container 32, such as medication card portions 34. In some embodiments, medication cards 60 are adhered to medication card portions 34 with an adhesive material. In some embodiments, scroll container 32 includes oppositely positioned flaps 38 at each medication card portion 34. Flaps 38 are attached with scroll container 32 at a fold line 40, and extend beyond a width of medication card portions 34 of scroll container 32. Flaps 38 are rotatable about folding lines 40 relative to medication card portions 34 through an angular range of 0 through about 360 degrees. Flaps 38 are configured to receive an adhesive material such that when folded along folding lines 40 and onto a medication card 60, flaps 38 will hold medication card 60 in place, as discussed herein.

Medicament dispensing system 10 is movable between an open position, such as, for example, a medication accessible configuration and a closed position, such as, for example, a child resistant configuration, as described herein. In a closed configuration, scroll container 32 is wound or rolled to prevent access to contents of medicament dispensing system 10, such as, for example, medication cards 60 contained therein. In an open configuration, scroll container 32 is rotatable, in the direction as shown by arrows B1 in FIG. 6, to facilitate ease of access to the contents of inner cavity 20 of sleeve 12.

When moving to the closed configuration, medication card portions 34 and spine portions 36 are rotated toward one another in an opposite direction, as shown by arrows B2 in FIG. 6. The user rotates each medication card portion 34 along folding lines 40 positioned between medication card portions 34 and spine portions 36. A user rotates each consecutive medication card portion 34 and spine portion 36 in turn starting at a terminal end until all medication cards 60 are enclosed on the inside of scroll container 32.

Scroll container 32 comprises one or more medication cards 60 that store and/or contain one or more medications, such as, for example, a dose of at least one medication. The dose of medication(s) is enclosed and sealed in a plurality of receptacles 72. In some embodiments, scroll container 32 includes a plurality of medication cards 60. Each medication card 60 is held in place by oppositely positioned flaps 38 that are folded to contact and adhere to a front-facing inner surface of medication card 60. In some embodiments, each medication card 60 encloses a different medication such that each medication that is part of a patient's dosage regimen is organized on separate medication cards 60.

In some embodiments, medication card 60 comprises receptacles 72 indicating a patient's daily dosage of medication held within medication card 60. In some embodiments, medication card 60 comprises indicia 74, disposed with and displayed from a predetermined portion adjacent one or more receptacles 72, indicating information regarding the medication enclosed within receptacles 72.

In some embodiments, medicament dispensing system 10 comprises a disposable dispensing device that provides therapeutic and/or nutritional support to a patient by increasing compliance with a dosing regimen, as described herein. In some embodiments, medicament dispensing system 10 and/or one or more medication cards 60 include blister packs, which comprise a plurality of receptacles 72. In some embodiments, each receptacle 72 accommodates a dosage unit and isolates that dosage unit from other dosage units. In some embodiments, a biologically-active substance within each dosage unit will not come into contact with the biologically-active substance of other dosage units.

In some embodiments, medicament dispensing system 10 and/or one or more medication cards 60 include a blister pack comprising at least one row of a plurality of receptacles 72 and/or portions including indicia 74. In some embodiments, each receptacle 72 is designed to hold only one dosage unit having either only one biologically-active substance or multiple storage-compatible substances. In some embodiments, each receptacle 72 is designed to hold a plurality of dosage units.

In some embodiments, each predetermined portion including one or more receptacles 72 may have an independently removable or breakable seal. In some embodiments, each receptacle 72 is moisture resistant and independently sealed. In some embodiments, one or more receptacles 72 may comprise a blister pack including a push-through pack, which has a lid material of aluminum foil or aluminum foil laminate. In some embodiments, a base of one or more receptacles 72 may be plastic, such as, for example, PVC, polyamides, polyolefins, polyesters and laminates or multi-layered materials. In some embodiments, the lid foil of a receptacle 72 may be provided with a line of weakness in a region of each receptacle 72 such that the line of weakness may be a tab for gripping that enables a receptacle 72 to be exposed by manipulation of the lid foil.

In some embodiments, receptacle 72 may be made embossed, cast deep drawn or vacuum formed out of plastic, plastic laminates, plastic/paper laminates or plastic/metal foil laminates. In some embodiments, receptacle 72 comprises a barrier layer against gases and vapors, which may be fabricated from a metal foil such as an aluminum foil embedded in a plastic laminate or ceramic layers or metallic layers embedded between two plastic layers.

In some embodiments, a dose of medicament, medication or drug can include, such as, for example, a chewable tablet, quick dissolve tablet, effervescent tablet, reconstitutable powder, elixir, liquid, solution, suspension, emulsion, tablet, multi-layer tablet, bi-layer tablet, capsule, soft gelatin capsule, hard gelatin capsule, caplet, lozenge, chewable lozenge, bead, powder, granules, dispersible granules, cachets, douche, suppository, cream, topical, inhalant, aerosol inhalant, patch, particle inhalant, implant, depot implant, dragee, ampoule, ingestible, injectable, infusion, health bar, liquid, food, nutritive food, functional food, yogurt, gelatin, cereal, cereal coating, animal feed and/or combinations thereof.

In some embodiments, indicia 74 of a medication regimen, direction, instruction and/or prescription for administration of the medication regimen may include dosage day indicia, a specific day of the week, such as Monday, Tuesday, Wednesday, Thursday, Friday, Saturday, Sunday or an abbreviation of said day, a specific date or a general succession of days, such as day 1, day 2, day 3. In some embodiments, indicia 74 may include time indicia that may be, such as, for example, a general time of the day corresponding to each of receptacles 72 or a specific time of the day corresponding to each of receptacles 72, such as, for example, AM, PM, morning, afternoon, evening, day, night, daytime, nighttime and combinations thereof. In some embodiments, indicia 74 may include each separate row or column of a medication card 60 indicating a time of day, such as AM doses and PM doses. In some embodiments, receptacle 72 and/or an adjacent portion may be color coded for time indicia. In some embodiments, one or more components of medicament dispensing system 10 may include a key defining or explaining color coding. In some embodiments, mediation card 60 comprises indicia 74 to indicate the name and/or nature of the medications being administered. In some embodiments, indicia 74 include a list of possible side effects of the medications being administered. In some embodiments, indicia 74 provide instructions on how long a patient should take the medication being administered.

In some embodiments, a dose unit may comprise vitamin A, B vitamins, vitamin C, vitamin D, vitamin E, vitamin K, essential fatty acids, folic acid, iron, calcium, magnesium, potassium, copper, chromium, zinc, molybdenum, iodine, boron, selenium, manganese, derivatives thereof and/or combinations thereof. In some embodiments, biologically-active substances may include thiamin, thiamin pyrophosphate, riboflavin, flavin mononucleotide, flavin adenine dinucleotide, niacin, nicotinic acid, nicotinamide, niacinamide, nicotinamide adenine dinucleotide, tryptophan, biotin, pantothenic acid, ascorbic acid, retinol, retinal, retinoic acid, beta-carotene, 1,25-dihydroxycholecalciferol, 7-dehyrdocholesterol, alpha-tocopherol, tocopherol, tocotrienol, menadione, menaquinone, phylloquinone, naphthoquinone, calcium, calcium carbonate, calcium sulfate, calcium oxide, calcium hydroxide, calcium apatite, calcium citrate-malate, calcium gluconate, calcium lactate, calcium phosphate, calcium levulinate, phosphorus, potassium, sulfur, sodium, docusate sodium, chloride, magnesium, magnesium stearate, magnesium carbonate, magnesium oxide, magnesium hydroxide, magnesium sulfate, copper, iodine, zinc, chromium, molybdenum, carbonyl iron, ferrous fumarate, polysaccharide iron, and/or combinations and derivatives thereof.

In some embodiments, a dose unit may be prescription and/or non-prescription substances. In some embodiments, the prescription substance may be a hormone replacement agent, a contraceptive agent, an osteoporotic agent, a chemotherapeutic agent, an anti-infective agent, analgesic, a steroid, an appetite suppressant, a weight loss agent, a tobacco antagonist, a cholesterol reducer and/or combinations thereof.

In some embodiments, the prescription substances may include, such as, for example, ticagrelor (anti-platelet), clopidogrel (anti-platelet), prasugrel (anti-platelet), carvedilol (beta blocker), metoprolol succinate (beta blocker), metoprolol tartrate (beta blocker), lisinopril (ACE inhibitor), losartan (angiotensin receptor blocker), valsartan (angiotensin receptor blocker), atorvastatin (statin), simvastatin (statin), spironolactone (aldosterone receptor blocker/diuretic), atenolol, erythromycin, penicillins, cephalosporins, theophylline, albuterol, terbutaline, diltiazem, propranolol, nifedepine, clonidine, thioridazine, diazepam, meclizine, ergoloid mesylates, chlorpromazine, carbidopa, levodopa, beclomethasone diproprionate, budesonide, dexamehasone, flunisolide, fluticasone proprionate, mometasone furoate, triamcinolone acetonide, beconase, pulmicort, rhinocort, decadron, aerobid/nasolide, flovent/flonase, azmacort, amprenavir, adefovir dipivoxil, zidovudine, azidothymidine, AZT, paclitaxel, cyclophosphamide, teniposide, taxol, cytoxan, vumon, methotrexate, methotrexate, cisplatin, carboplatin, oxaliplatin, platinol, paraplatin, adriamycin, bleomycin, dactinomycin, daunorubicin, doxorubicin, indarubicin, mitomycin, blenoxane, cosmegen, cerubidine, rubex, indamycin, mutamycin, BCNU, streptozocin, vinblastine, thiotepa, conjugated estrogens, esterified estrogens, estropipate, estradiol, ethinyl estradiol, medroxyprogesterone, meprobamate, desogestrel, levonorgestrel, norethindrone, norethindrone acetate, norgestimate, norgestrel, raloxifene, tamoxifen, methyltestosterone, quinapril, sotalol, alendronate, atorvastatin, colestipol, clofibrate, and/or combinations thereof.

In some embodiments, the non-prescription substance can be a vitamin or derivative thereof, and/or a mineral compound or derivative thereof. In some embodiments, the vitamin or mineral compound may be, such as, for example, thiamin, thiamin pyrophosphate, riboflavin, flavin mononucleoride, flavin adenine dinucleotide, niacin, nicotinic acid, nicotinamide, niacinamide, nicotinamide adenine dinucleotide, tryptophan, biotin, folic acid, pantothenic acid, ascorbic acid, retinol, retinal, retinoic acid, beta-carotene, 1,25-dihydroxycholecalciferol, 7-dehydrocholesterol, alpha-tocopherol, tocopherol, tocotrienol, menadione, menaquinone, phylloquinone, naphthoquinone, calcium, calcium carbonate, calcium sulfate, calcium oxide, calcium hydroxide, calcium apatite, calcium citrate-malate, calcium gluconate, calcium lactate, calcium phosphate, calcium levulinate, phosphorus, potassium, sulfur, sodium, docusate sodium, chloride, magnesium, magnesium stearate, magnesium carbonate, magnesium oxide, magnesium hydroxide, magnesium sulfate, copper, iodine, zinc, chromium, molybdenum, carbonyl iron, ferrous fumarate, polysaccharide iron, and combinations and derivatives thereof. In some embodiments, the derivatives of vitamin compounds include salts, alkaline salts, esters and chelates of any vitamin compound. In some embodiments, the nonprescription substance can be a herbal compound, herbal extract, derivative thereof and/or combinations thereof.

In some embodiments, a medication regimen can include a first dosage unit arrayed on a blister pack of receptacles 72 adjacent to a second dosage unit. In some embodiments, the medication regimen includes a first dosage unit disposed adjacent to a second dosage unit disposed with different receptacles 72.

In some embodiments, medication card 60 comprises seven receptacles 72. One dosage unit is enclosed in each receptacle 72. Receptacles 72 are horizontally arranged in a row adjacent to one another. Medication card 60 comprises indicia 74 indicating the time and/or order in which the medications are to be taken by the patient. In some embodiments, each receptacle 72 is labeled with an arrow having the day the dosage should be taken according to a dosage regimen. Indicia 74 are screen printed on medication card 60. In some embodiments, indicia 74 may be hand written. Sections of medication card 60 may be left blank to allow hand written notes or instructions by a patient, pharmacist or doctor.

In some embodiments, scroll container 32 includes several medication cards 60 adhered to medication card portions 34 and spaced apart by spine portions 36. In some embodiments, each medication card 60 includes one row of seven receptacles 72. Each receptacle 72 is positioned adjacent indicia 74 to provide information relating to the medicaments held within the receptacles. Medication cards 60 are aligned on the surface of scroll container 32 such that each row of receptacles 72 align into columns such that a first receptacle 72 of each medication card 60 is aligned into a first column, a second receptacle 72 of each medication card 60 is aligned into a second column, a third receptacle 72 of each medication card 60 is aligned into a third column, etc. The arrangement of receptacles 72 aids a user in maintaining compliance with a complex dosage regimen. Thus, compliance with a complex dosage regimen, such as a regimen requiring multiple medications each day, is made easier by having visibility of each of the medications required to be taken at once in a column view. Similarly, a patient can easily tell which medicaments have been taken already, and which medicaments have yet to be taken by looking to the columns of receptacles 72 which have been broken.

In some embodiments, medicament dispensing system 10 comprises one or more information labels to educate a patient about a medication being administered in the dosage regimen. In some embodiments, the label comprises indicia to indicate the name and/or nature of the medicine being administered. In some embodiments, the indicia include a list of possible side effects of the medications being administered. In some embodiments, the indicia provide instructions on how long a patient should take the medication being administered. In some embodiments, the label is a sticker that is adhered onto a front-facing surface and/or a rear-facing surface of a housing and/or medication container.

Medicament dispensing system 10, similar to the systems and methods described herein, including medicament scroll container 32 and sleeve 12, as described herein, is employed in connection with treatment of a disease, illness and/or ailment of a patient. The components of medicament dispensing system 10 facilitate user/patient compliance with a medication regimen, as described herein, upon discharge from a health care facility, such as, for example, a hospital. In one embodiment, a patient utilizes medicament dispensing system 10 after being discharged from a hospital following a myocardial infarction and may be prescribed and/or directed to administer one or a plurality of prescription and/or non-prescription medications. For example, a patient may be prescribed an antiplatelet agent, aspirin, warfarin (anti-coagulant), a beta-blocker, an ACE inhibitor, a statin, nitro-glycerin, a docusate, and/or antidepressants in connection with treatment for the myocardial infarction.

In some embodiments, a medical practitioner and/or pharmacist reviews and/or considers medications including one or more prescriptions in connection with treatment for the myocardial infarction, one or more non-prescribed medications directed for administration by the patient in connection with treatment for the myocardial infarction, one or more existing prescriptions and/or one or more non-prescription medications and supplements being taken by the patient. The medical practitioner and/or pharmacist determine a medication regimen based on these medications using medicament dispensing system 10 to facilitate user/patient compliance with the medication regimen.

In some embodiments, based on the determined medication regimen, health care personnel, such as, for example, pharmacy personnel prepare selected medication cards 60 and/or labels, as described herein, for disposal with a selected scroll container 32 specifically created for the myocardial infarction and the user/patient upon discharge from the hospital.

In use, medicament dispensing system 10 is initially disposed in the child resistant locked configuration such that protrusions 104 are engaged with surfaces 108. Protrusions 106 are in an offset alignment relative to opening 22 to obstruct passage of buttons 102 through openings 22. Surfaces 104, 108 are disposed in an interference fit to resist and/or prevent disengagement of scroll container 32 from sleeve 12. To open medicament dispensing system 10, buttons 102 are manipulated and/or translated by sliding scroll container 32, in a direction shown by arrow D in FIG. 3, causing buttons 102 to align with openings 22 and disengage from surface 108. Movement of buttons 102 allows buttons 102 to pass through openings 22 without obstruction. Once buttons 102 are aligned with openings 22, buttons are pushed in a downward direction, as shown by arrow E in FIG. 4, to release scroll container 32 from sleeve 12.

The contents of scroll container 32, which may include medication cards 60 and/or information labels, as described herein, are accessible to the user/patient. The user/patient employs the components of medicament dispensing system 10, for example, following direction via indicia 74 for administering dosage units from receptacles 72 and/or following instruction from indicia 74 and/or labels, to facilitate user/patient compliance with the medication regimen in connection with treatment for the myocardial infarction.

Once a patient has accessed the medication required for the dosage regimen, scroll container 32 is wound or rolled, in the direction shown by arrows D in FIG. 3, to close scroll container 32. Scroll container 32 is rotated relative to tether 33 to a closed configuration, as described herein. Scroll container 32 is translated into inner cavity 20 of sleeve 12. Buttons 102 are moved to a locked position, as described herein, such that scroll container 32 is disposable in a child resistant, locked configuration with sleeve 12 for storage and subsequent use.

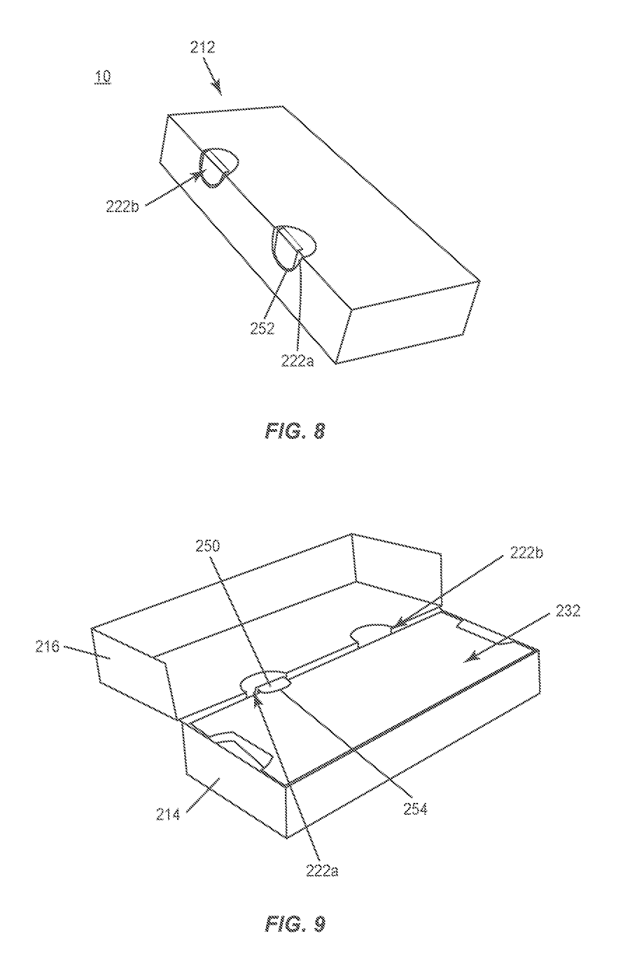

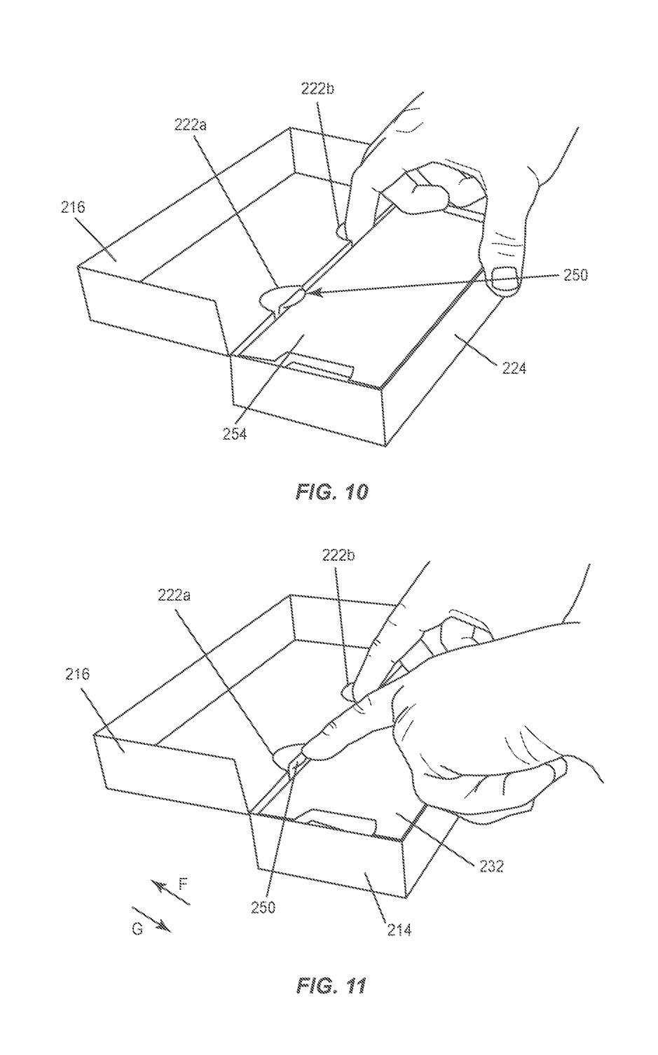

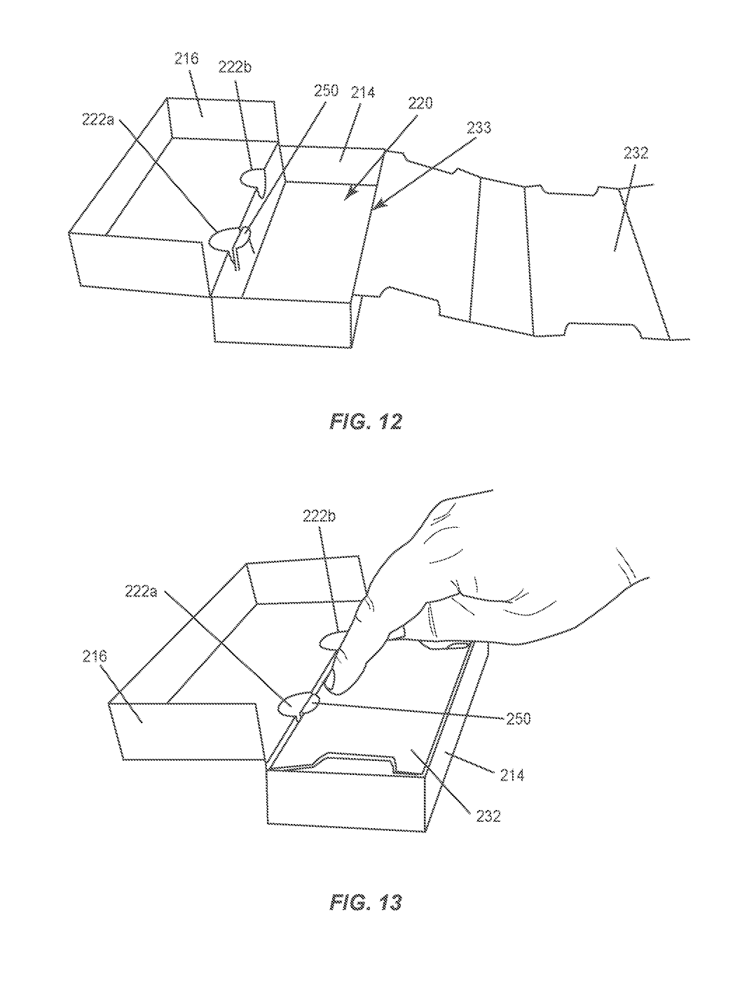

In one embodiment, as shown in FIGS. 8-13, medicament dispensing system 10, similar to the systems and methods described herein, includes a housing, such as, for example, a box 212 having a generally rectangular cross-sectional shape. Box 212 includes a bottom 214 and a cover 216. In one embodiment, bottom 214 and cover 216 include a rectangular shape. Bottom 214 includes a surface that defines an inner cavity 220, as shown in FIG. 12. Inner cavity 220 is configured to receive a medication container, such as, for example, a scroll container 232, similar to scroll container 32 as described herein. Cover 216 is configured to provide access to inner cavity 20. In some embodiments, all or only a portion of box 12 may have alternate cross section configurations, such as, for example, oval, oblong triangular, square, polygonal, irregular, uniform, non-uniform, offset, staggered, and/or tapered.

Scroll container 232 is configured for disposal within inner cavity 220, as described herein. Scroll container 232 is attached with box 212 by a tether 233, similar to tether 33 described herein. Tether 233 is configured such that scroll container 232 is drawn from box 212 but not detachable from box 212. Tether 233 is configured to provide a range of motion for movement of scroll container 232 relative to box 212. In some embodiments, scroll container 232 is pivotable about tether 233 in an angular range of 0 to 360 degrees.

In some embodiments, medicament dispensing system 10 is movable between a child resistant locked and/or medication non-accessible configuration and an unlocked and/or medication accessible configuration. In some embodiments, cover 216 includes one or a plurality of openings. In some embodiments, cover 216 includes a pair of openings 222a, 222b, as shown in FIG. 8. In some embodiments, openings 222a, 222b are disposed with a back corner of cover 216. In some embodiments, openings 222a, 222b include a circular configuration. In some embodiments, all or only a portion openings 222a, 222b may have alternate cross section configurations, such as, for example, oval, oblong triangular, square, polygonal, irregular, uniform, non-uniform, offset, staggered, and/or tapered.

In some embodiments, box 212 includes a tab, such as, for example, a spring tab 250. Tab 250 is connected with a surface 252 of one of openings 222a, 222b, such as, for example, opening 222a. Tab 250 is configured for disposal between a child resistant locked configuration, as shown in FIG. 8, and an opened, non-locked configuration, as shown in FIG. 11. Tab 250 is resiliently biased in the locked configuration to facilitate locking of scroll container 232. In the child resistant locked configuration, tab 250 is engageable with a surface 254 of scroll container 232, as shown in FIG. 9. Engagement of tab 250 and surface 254 forms an interference fit to resist and/or prevent disengagement of scroll container 232 from box 212. In the locked configuration, the interference fit is formed by a resilient force applied by tab 250 to scroll container 232, as described herein. In some embodiments, box 212 includes one or a plurality of tabs, as described herein, and for example, a tab 250 can be disposed with each of openings 222a, 222b.

To open box 212, the patient manipulates, rotates and/or lifts tab 250 to pivot tab 250, in a direction shown by arrow F in FIG. 11, causing tab 250 to move out of alignment with scroll container 232 and release scroll container 232. The patient simultaneously manipulates scroll container 232, in a direction shown by arrow G in FIG. 11, by insertion of a finger into opening 222b to draw or pull scroll container 232 from box 212. Scroll container 232 is released to the opened configuration to access medication.

In some embodiments, instructive indicia are positioned adjacent openings 222a, 222b to aid a user in moving medicament dispensing system 10 from the child resistant locked configuration to the unlocked configuration. In some embodiments, the indicia are positioned on a surface of box 212 and/or adjacent openings 222a, 222b. In some embodiments, the indicia may be marked by an arrow indicating the direction of movement to move tab 250.

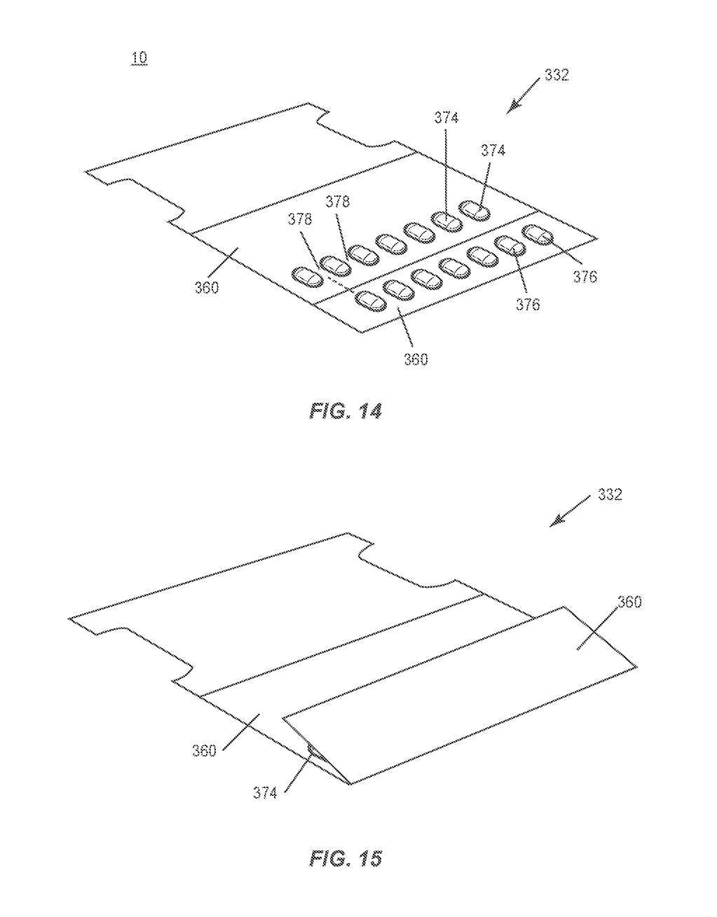

In one embodiment, as shown in FIGS. 14 and 15, medicament dispensing system 10, similar to the systems and methods described herein, includes a housing, such as, for example, a sleeve (not shown), similar to sleeve 12 as described herein. An inner cavity of the sleeve is configured to receive a medication container, such as, for example, a scroll container 332, similar to scroll container 32, as described herein. Scroll container 332 is attached with the sleeve by a tether (not shown), as described herein. In some embodiments, scroll container 332 includes one or more medication cards 360, similar to medication cards 60, as described herein, that store and/or contain medications, such as, for example, medications that are required to be taken two times a day. The dose of medication(s) is enclosed and sealed in a plurality of receptacles, such as, for example, morning dose receptacles 374 and evening dose receptacles 376. In some embodiments, receptacles 374 are disposed linearly across medication card 360. In some embodiments, receptacles 376 are disposed linearly on a second medication card 360. In some embodiments, the receptacles 376 are disposed offset and/or staggered relative to receptacles 374. This configuration allows receptacles 376 to nest within gaps 378 disposed between receptacles 374 when scroll container 332 is rolled closed, as shown in FIG. 15. In some embodiments, scroll container 332 comprises a medication card, as described herein, which is connected to an existing tether of a sleeve and medication container, as described herein.

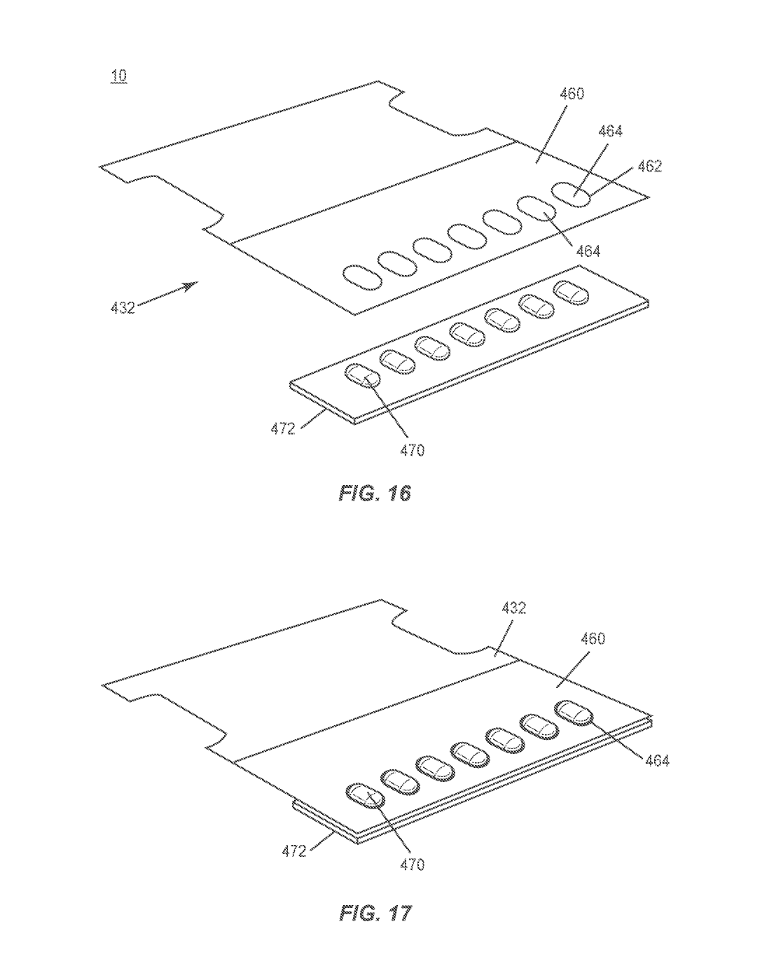

In one embodiment, as shown in FIGS. 16 and 17, medicament dispensing system 10, similar to the systems and methods described herein, includes a housing, such as, for example, a sleeve (not shown), similar to sleeve 12 as described herein. An inner cavity of the sleeve is configured to receive a medication container, such as, for example, a scroll container 432, similar to scroll container 32, as described herein.

Scroll container 432 is configured for disposal within the inner cavity, as described herein. Scroll container 432 is attached with the sleeve by a tether (not shown), as described herein. In some embodiments, scroll container 432 includes one or more medication cards 460, similar to medication cards 60, as described herein, that store and/or contain medications. In some embodiments, one or more of medication cards 460 include a surface 462 that define a plurality of openings 464. In some embodiments, openings 464 are disposed linearly across medication card 460.

In some embodiments, the dose of medication(s) is enclosed and sealed in a plurality of receptacles 470 disposed with a portion, such as, for example, a strip 472, as shown in FIG.16. . . . In some embodiments, receptacles 470 are disposed linearly across strip 472. In some embodiments, strip 472 is attachable to a designated portion on medication card 460 such that receptacles are aligned with openings 464. In some embodiments, strip 472 is attached with medication cards 460 with an adhesive material. In some embodiments, scroll container 432 comprises a medication card, as described herein, which is connected to an existing tether of a sleeve and medication container, as described herein.

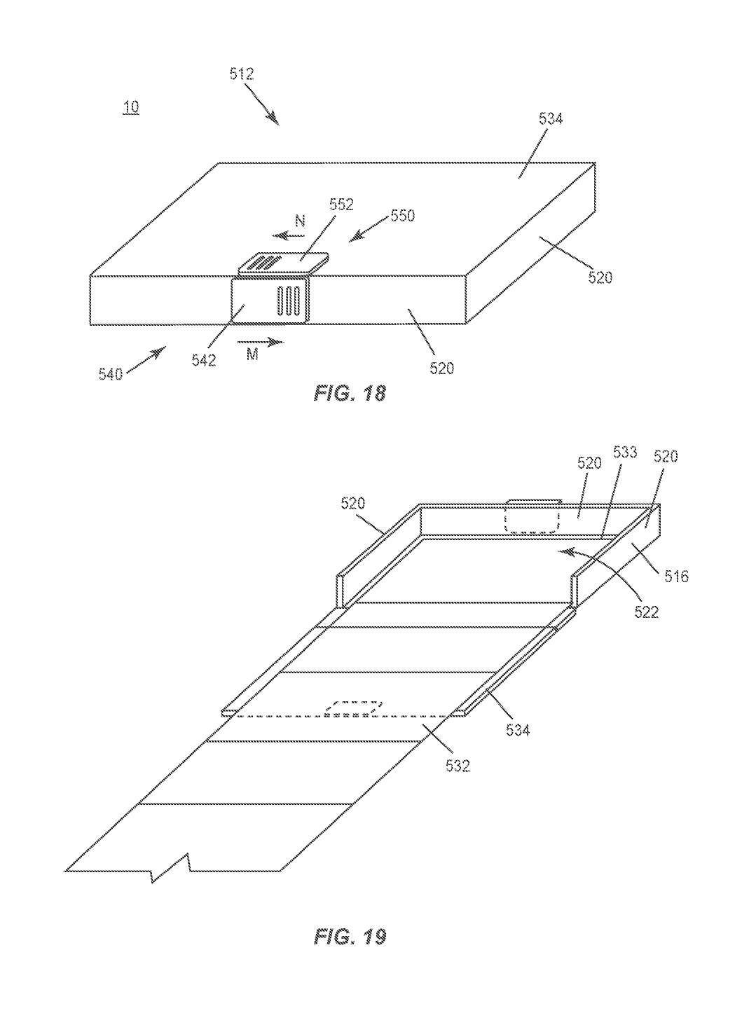

In one embodiment, as shown in FIGS. 18-23, medicament dispensing system 10, similar to the systems and methods described herein, includes a housing, such as, for example, a box 512, similar to box 212 as described herein. Box 512 includes a bottom section 516 having walls 520 that define an inner cavity 522. A scroll container 532 is configured for disposal within inner cavity 522, as described herein. Scroll container 532 is attached with box 512 by a tether 533, similar to tether 33 described herein. In some embodiments, medicament dispensing system 10 is movable between a child resistant locked configuration and an unlocked and/or medication accessible configuration, as described herein. In some embodiments, box 512 includes a cover 534, as shown in FIGS. 18 and 19. As scroll container 532 folds into box 512, cover 534 closes box 512, as shown in FIG. 18.

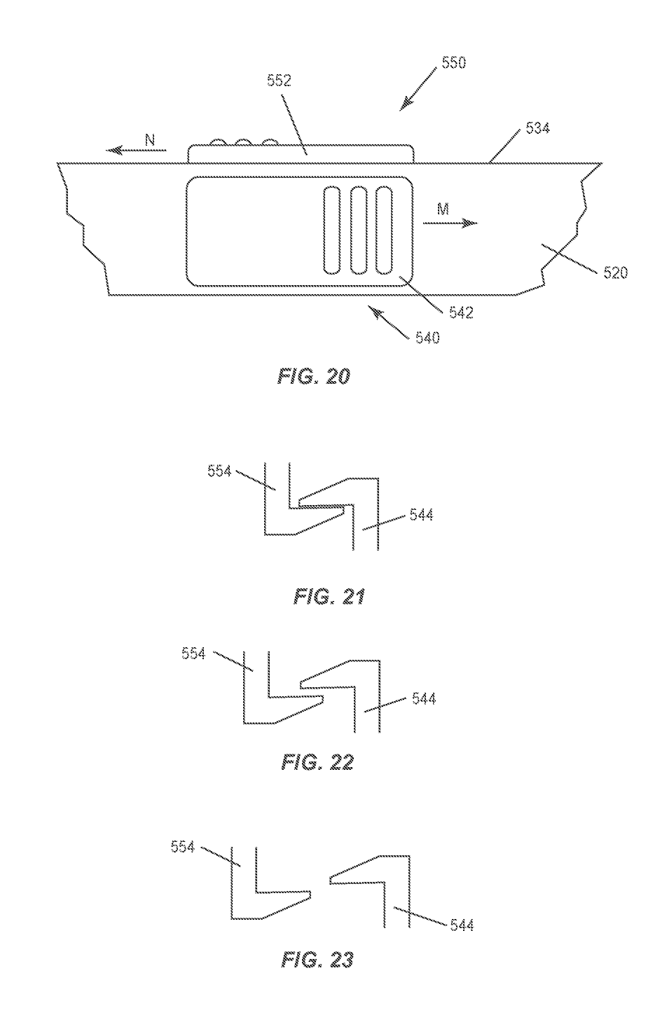

In some embodiments, one of sidewalls 520 includes a latch 540. Latch 540 includes a portion, such as, for example, a slide 542 that includes a hook 544. Slide 542 is configured for translation in a direction, as shown by arrow M in FIGS. 18 and 20, causing hook 544 to translate. In some embodiments, cover 534 includes a latch 550. Latch 550 includes a portion, such as, for example, a slide 552 that includes a hook 554. Hook 554 is engageable with hook 544 in the child resistant locked configuration. Slide 552 is configured for translation in a second, opposite direction, as shown by arrow N in FIGS. 18 and 20, causing hook 554 to translate. Hooks 544, 554 are initially disposed in the child resistant locked configuration to resist and/or prevent access to scroll container 532, as shown in FIG. 21.

As slides 542, 552 are translated simultaneously in opposite directions, hooks 544, 554 are disengaged into the open medication accessible configuration, as shown in FIG. 23. Both slides 542, 552 are translated in opposite directions for disengagement from the child resistant locked configuration to the medication accessible opened configuration, and translation of a single slide 542 or 552 will not disengage the latch mechanism of box 512 and scroll container 532 from a child resistant locked configuration to a medication accessible opened configuration. In some embodiments, the latch mechanism of box 512 and scroll container 532 automatically engages and disposes box 512 and scroll container 532 in the child resistant locked configuration when scroll container 532 is returned to the closed position with box 512. As cover 534 is closed with box 512, hooks 544, 554 engage and deflect via spring biased engagement and return to a locked configuration, as shown in FIG. 21.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. Medication packaging comprising:
a housing; and
a medication container attached with the housing by a tether;
wherein the medication container is engageable with the housing between a child resistant configuration and a medication accessible configuration.

2. Medication packaging as recited in claim 1, wherein the medication container includes a protrusion engageable with a surface that defines an opening of the housing in the child resistant configuration.

3. Medication packaging as recited in claim 2, wherein the protrusion includes a lateral projection engageable with the surface to capture the medication container with the housing in the child resistant configuration.

4. Medication packaging as recited in claim 1, wherein the housing includes a protrusion engageable with a surface of the medication container in the child resistant configuration.

5. Medication packaging as recited in claim 1, wherein the housing includes a first latch and a second latch engageable in the child resistant configuration.

6. Medication packaging as recited in claim 5, wherein each of the latches include a resiliently biased hook.

7. Medication packaging as recited in claim 1, wherein the housing includes a first latch and the medication container includes a second latch, the first and second latches are engageable in the child resistant configuration.

8. A medication packaging system comprising:
medication packaging comprising:
a housing;
a medication container attached with the housing by a tether;
at least one member connected to the container, the at least one member defining at least one compartment and including indicia relating to a medication regimen; and
at least one dose of at least one medication disposable in the at least one compartment;
wherein the medication container is engageable with the housing in a child resistant configuration.

9. A medication packaging system as recited in claim 8, wherein the medication container includes a protrusion engageable with a surface that defines an opening of the housing in the child resistant configuration.

10. A medication packaging system as recited in claim 9, wherein the protrusion includes a lateral projection engageable with the surface to capture the medication container with the housing in the child resistant configuration.

11. A medication packaging system as recited in claim 8, wherein the housing includes a protrusion engageable with a surface of the medication container in the child resistant configuration.

12. A medication packaging system as recited in claim 8, wherein the housing includes a first latch and a second latch engageable in the child resistant configuration.

13. A medication packaging system as recited in claim 12, wherein each of the latches include a resiliently biased hook.

14. A medication packaging system as recited in claim 8, wherein the housing includes a first latch and the medication container includes a second latch, the first and second latches are engageable in the child resistant configuration.

15. A medication packaging system as recited in claim 14, wherein the first latch includes a slide and the second latch includes a slide engageable in the child resistant configuration.

16. A medication packaging system as recited in claim 14, wherein the first latch includes a protrusion and the second latch includes a protrusion engageable in the child resistant configuration.

17. A medical compliance method for a discharged patient, the method comprising the steps of:
treating a patient for an illness;
reviewing a medical therapy for treating the illness, the medical therapy comprising a medical regimen that includes at least one dose of at least one medication; and
providing medication packaging comprising:
a housing;
a medication container attached with the housing by a tether;
at least one member connected to the medication container, the at least one member defining at least one compartment and including indicia relating to a medication regimen; and
at least one dose of at least one medication disposable in the at least one compartment;
wherein the medication container is engageable with the housing in a child resistant configuration.

18. A medical compliance method as recited in claim 17, wherein the medication container includes a protrusion engageable with a surface that defines an opening of the housing in the child resistant configuration.

19. A medical compliance method as recited in claim 17, wherein the housing includes a first latch and a second latch engageable in the child resistant configuration.

20. A medical compliance method as recited in claim 17, wherein the housing includes a first latch and the medication container includes a second latch, the first and second latches are engageable in the child resistant configuration.
